(19) United States
(12) Patent Application Publication
(10) Pub. No.: US 2014/0339443 A1
(43) Pub. Date: Nov. 20, 2014

(54) COLLIMATING APPARATUS FOR EMISSION TOMOGRAPHY

(71) Applicant: Zhiping MU, Chongqing (CN)

(72) Inventor: Zhiping MU, Chongqing (CN)

(21) Appl. No.: 14/285,398

(22) Filed: May 22, 2014

Related U.S. Application Data
(63) Continuation of application No. PCT/CN2012/085082, filed on Nov. 22, 2012.

(30) Foreign Application Priority Data
Nov. 25, 2011 (CN) 201120476341.8

(51) Int. Cl. G21K 1/02; G01T 1/29

(52) U.S. Cl. CPC G21K 1/02; G01T 1/2985
USPC 250/505.1

(57) ABSTRACT

Disclosed is a collimating apparatus for emission tomography. The collimating apparatus comprises a perforated plate (1) that is disposed between a detector (2) and a to-be-detected object and provided with a plurality of through holes (5); wherein a minimum distance between central points of each two adjacent through holes (5) is t, and a distance from the central point of the through hole (5) to the wall of the through hole (5) is half of Φ, where t>Φ>t/2. The perforated plate (1) comprised in the collimating apparatus addresses problems of both the stability of portions surrounding the through holes (5) and the aperture ratio of the perforated plate (1), and ensures sensitivity of the detector (2).

### CROSS-REFERENCE TO RELATED APPLICATIONS

This application is a continuation of International Patent Application No. PCT/CN2012/085082, with an international filing date of Nov. 22, 2012, designating the United States, now pending, which is based on Chinese Patent Application No. 201120476341.8, filed Nov. 25, 2011. The contents of these specifications are incorporated herein by reference.

### TECHNICAL FIELD

The present invention relates to an apparatus for image reconstruction by detecting radiation rays, and in particular, to a collimating apparatus for use in a medical imaging device.

### BACKGROUND

In modern medical imaging technologies, images of a concerned anatomical part are reconstructed by collecting y-photons or X-rays with detectors. Typically, a collimator made of a heavy metal needs to be disposed between a detector and a to-be-detected object, such that photons emitted from the to-be-detected object are collimated. One type of such collimator is a perforated plate. Generally, a perforated plate is designed such that projections formed by projecting the to-be-detected object through a plurality of through holes disposed on the perforated plate are spaced apart from each other, thereby preventing aliasing. In this case, the number of holes on the perforated plate is small, not exceeding 10; the spacing between holes is large, much larger than the hole diameter. Another type of such perforated plate, for example, a coded aperture plate, has a greater hole density, wherein the holes are arranged according to a certain matrix. There exists a situation where the surrounding elements of a small portion in the matrix may be all open (or through) holes. Therefore, if the hole diameter is the same as the hole spacing, such perforated plate cannot achieve “self-supporting”. To achieve “self-supporting”, and to avoid dropping off of portions surrounded by open holes during fabrication, the hole diameter is required to be smaller than the minimum center distance between adjacent holes. Because the collected image needs to be digitized, the perforated plate also needs to be sampled and then digitized. Currently, conventional processing and sampling methods require that the hole diameter be 1/n of the center distance, where n is an integer greater than 1. This is intended to achieve correct sampling of the plate, and also preserve digital spectrum characteristics of the hole pattern, such as correlation properties and the like. In such design, the maximum value of the hole diameter is ½ of the center distance, or the center distance is twice the hole diameter. In literature, this scheme is called “No-Two-Holes-Touching”, i.e., NTHT. However, the aperture ratio of the perforated plate is small under the above technical solution. Even in the best case of n=2, the aperture ratio is only ¼ of the original hole matrix. When the perforated plate is applied to single photon emission computed tomography, i.e., SPECT, or applied to positron emission tomography, i.e., PET, the transmittance is low, and the detection sensitivity of the system is adversely affected.

### SUMMARY

The present invention is directed to providing a collimating apparatus for emission tomography, wherein the perforated plate comprised in the collimating apparatus addresses problems of both the stability of portions surrounding the through holes (5) and the aperture ratio of the perforated plate (1), and ensures sensitivity of the detector (2).

The technical solution to achieve the objective of the present invention is as follows: a collimating apparatus for emission tomography, comprising: a perforated plate that is disposed between a detector and a to-be-detected object and provided with a plurality of through holes; wherein a minimum distance between the central points of each two adjacent through holes is t; and a distance from the central point of the through hole to the wall of the through hole is half of Φ, where t>Φ>t/2.

When the through holes are square holes, Φ is twice the perpendicular distance from the center point to the wall of the through hole. In this way, two adjacent holes will not be in contact, which leaves a sufficient hole spacing to ensure self-supporting. When the through holes are circular holes, the central point is the center of the circle of the through hole, and Φ is the diameter. If the cross section of the hole is not circular but is in a convex shape, i.e., a shape where line segments between any two points on the edge of the hole remain inside the shape, the hole diameter refers to the diameter of a maximum inscribed circle of the cross section. Further, Φ is twice a maximum distance or a minimum distance from the central point of the through hole to the wall of the through hole.

The through holes are circular holes, wherein the central point is the center of a circle, Φ is a diameter, and t>Φ>t/1.95. To achieve a better detection effect, the Φ values of all the through holes are the same. However, to adapt to different application scenarios, the Φ value of the through holes may be different. In this case, Φ takes the maximum value of the Φ values of all the through holes. When the through holes are circular holes, the Φ value is the diameter of a hole having the maximum diameter. Optionally, the through holes are arranged as a matrix on the perforated plate; in the same row or in the same column, the minimum distance between the central points of two adjacent through holes is t; Φ is twice the maximum distance or the minimum distance from the central point of the through hole to the wall of the through hole.

Furthermore, the through holes are diameter-variable holes, Φ is an average diameter, and t>Φ>t/1.95. Φₛ is the minimum diameter, or t>Φₛ and Φ>t/1.95. The minimum diameter Φₛ is the diameter at the narrowest portion of the through hole.

A shielding apparatus I is disposed between the perforated plate and the detector, and a shielding apparatus II is disposed between the perforated plate and the to-be-detected object. A perpendicular distance and/or a relative horizontal position between the perforated plate and the detector are/is changed by adjusting the perforated plate and/or the detector. The open space of the shielding apparatus II is adjusted by stretch and retraction, and the perpendicular distance and/or the relative horizontal position between the shielding apparatus II and the perforated plate are/is adjustable. The detector, the perforated plate, and the shielding apparatus I may move together to detect projections from a plurality of angles by rotation or deployment at different angles.

There may be a variety of ways to implement the above adjustment. To be specific, the open space of the shielding apparatus II is adjusted by stretch and retraction, and the perpendicular distance and/or the relative horizontal position between the shielding apparatus II and the perforated plate are/is adjustable.

The perforated plate is a planar coded aperture plate provided with holes that are evenly spaced according to a matrix function h(x, y), where (x, y) denotes the coordinates of the planar coded aperture plate. The matrix function h(x, y) may be a modified uniformly redundant array, a uniformly redundant array, a random array, or a pseudo-random array. The through holes are located where the matrix function h(x, y)=1, and the coordinates where the matrix function h(x, y)=1 are coordinates of the central points of the through holes.

### BRIEF DESCRIPTION OF THE DRAWINGS

The apparatus of the present invention can be described in detail through the non-restrictive embodiments illustrated in the accompany drawings.

FIG. 1 is a schematic structural view of a collimating apparatus according to the present invention;

FIG. 2 is a schematic view of a perforated plate according to the present invention;

FIG. 3 is a schematic view of a diameter-variable through hole according to the present invention; and

FIG. 4 is a schematic view of the field of view of the apparatus according to the present invention.

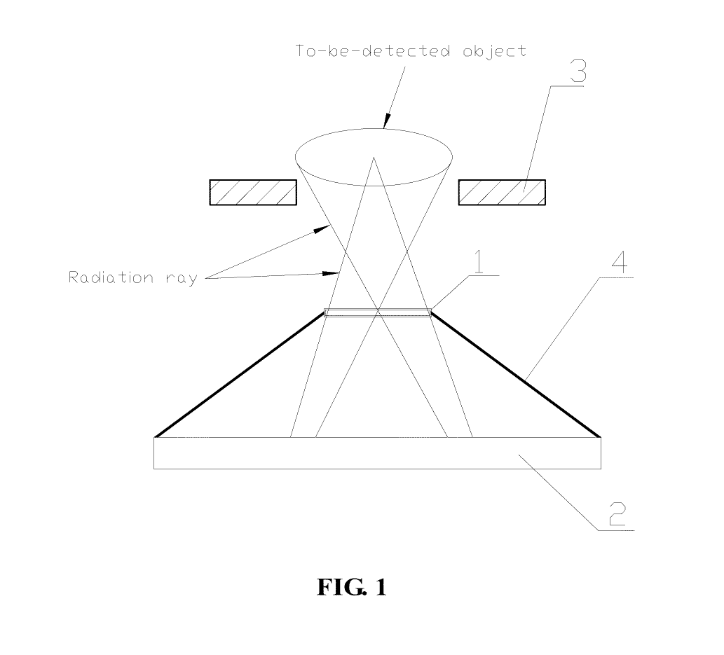

In the drawings, 1 denotes a perforated plate, 2 denotes a detector, 3 denotes a shielding apparatus I, 4 denotes a shielding apparatus II, 5 denotes a through hole, 6 denotes adjacent hole regions, Φ denotes a through hole diameter, t denotes a through hole center distance, Φ1 denotes a minimum diameter of a diameter-variable through hole, and Φ2 denotes a maximum diameter of a diameter-variable through hole.

### DETAILED DESCRIPTION

The present invention is further described with reference to the accompanying drawings and the following exemplary embodiments. However, it should not be interpreted as that the scope of the present invention is limited to only such exemplary embodiments. Various equivalent variations or replacements derived based on common knowledge and common technical means in the art without departing from the spirit of the present invention shall fall within the scope of the present invention.

Referring to the drawings, a collimating apparatus for emission tomography illustrated in the drawings comprises a perforated plate 1 and a detector 2, wherein: the perforated plate 1 is disposed between the detector 2 and a to-be-detected object and provided with a plurality of through holes 5.

### Embodiment 1

The through holes 5 are arranged as a matrix on the perforated plate 1; in the same row or in the same column, the distance between the central points of each two adjacent through holes 5 is t; and the distance from the central point of the through hole 5 to the wall of the through hole 5 is half of Φ, where t>Φ>t/2.

Furthermore, in order to achieve higher aperture ratio, the through holes 5 are circular holes, where, Φ is the diameter, t>Φ>t/1.95.

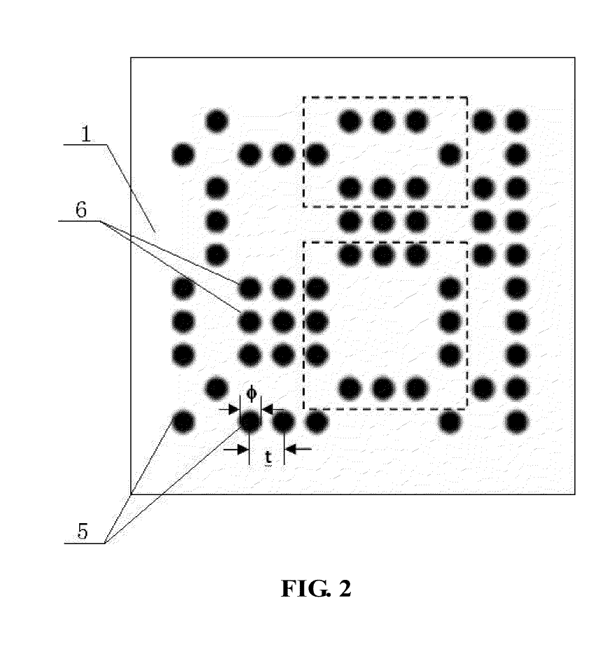

Considering that if t approximates Φ, there may not exist a physical hole wall portion between two adjacent through holes, i.e., the adjacent through holes are communicated with each other. With respect to the nine adjacent through holes in region 6 as illustrated in FIG. 2, gaps between any two through holes may be removed, therefore forming one large through hole. In this case, the through hole is considered as a synthesis hole of adjacent individual through holes, and the determined value of Φ is the hole diameter of each individual hole, and t is the distance between the centers of the individual through holes.

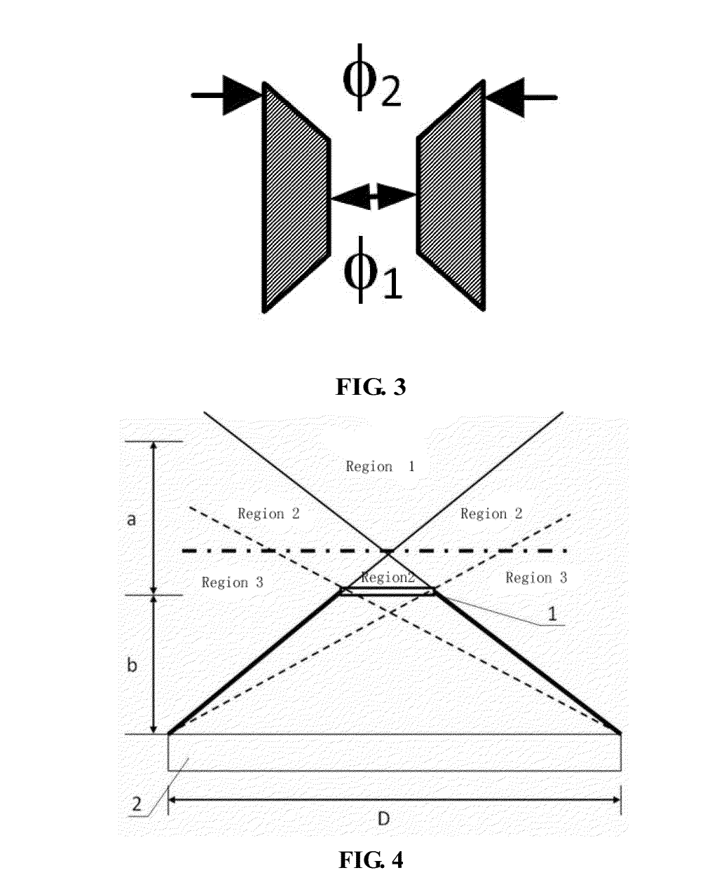

In an embodiment of the present invention, the through holes 5 may be irregularly-shaped holes. Particularly, as shown in FIG. 3, the through holes 5 are diameter-variable holes, where Φ1 is the diameter at the narrowest portion, and Φ2 is the diameter at the widest portion. The relationship between the center of the through hole and the minimum diameter of the through hole is t>Φ1, and the relationship between the center of the through hole and the average hole diameter is (Φ1+Φ2)/2>t/1.95.

To improve the signal-to-noise ratio, a shielding apparatus I is disposed between the perforated plate and the detector. A shielding apparatus II capable of adjusting position according to the size of the to-be-detected object is disposed between the perforated plate and the to-be-detected object. The shielding apparatus I covers the space between the outer edge of the perforated plate and the outer edge of the detector array, and is directed to preventing incident photons not passing through the perforated plate from reaching the detector. The shielding apparatus II is directed to limiting field of view (FOV) of the apparatus. If there is no shielding apparatus II, the FOV of the system is as illustrated in FIG. 4. In FIG. 4, “region 1” is the complete imaging region, i.e., straight line projection points formed by photons emitted from this region passing through the perforated plate are all within the range of the detector; “region 2” is a partial imaging region, i.e., straight line projection points formed by photons emitted from this region passing through the perforated plate are partially within the range of the detector, and some of the straight line projection points are outside the range of the detector; and “region 3” is a non-imaging region, i.e., straight line projection points formed after photons emitted from this region pass through the perforated plate are all outside the range of the detector. The shielding apparatus II is directed to blocking the photons emitted from “region 2” from reaching the perforated plate, thereby defining the imaging space range of the apparatus. Since in the absolutely imaging region, i.e., “region 1”, all the straight line projection points are above the dotted-lines, in general, the opening of the shielding apparatus II should be arranged above the dotted-lines.

It can be seen from FIG. 4, the FOV changes with the relative position of the perforated plate and the detector. Therefore, the FOV can be adjusted by adjusting the relative position of the perforated plate and the detector, mainly by adjusting a relative distance b. In addition, the adjusting of the relative position of the perforated plate and the detector includes translation parallel to the direction of perforated plate on the surface, or adjusting the distance between the shielding apparatus II and the perforated plate, and adjusting the opening of the shielding apparatus II, which may all limit or define the FOV.

### Embodiment 2

The perforated plate according to the present invention may be a coded aperture plate made by a heavy metal or an alloy of heavy metals. The shielding apparatus I is disposed between the perforated plate 1 or the coded aperture plate, and the detector 2. The shielding apparatus II adjustable according to the size of the to-be-detected object is disposed between the perforated plate 1 or the coded aperture plate, and the to-be-detected object. The perforated plate 1 or the coded aperture plate is parallel with the surface of the detector. The shielding apparatus I and the shielding apparatus II are also made by a heavy metal or an alloy of heavy metals, which effectively shield the interference and achieve a desired signal-to-noise ratio.

Further, the perforated plate is a planar coded aperture plate coded based on a matrix function h(x, y), where (x, y) denotes coordinates of the planar coded aperture plate.

The through holes are provided where the matrix function h(x, y)=1, and coordinates where the matrix function h(x, y)=1 are coordinates of the central point of the through hole 5.

In conventional coded aperture plate design, to avoid dropping off of portions surrounded by through holes, an NTHT design scheme is employed. Under such a scheme, the hole spacing of the perforated plate or the coded aperture plate is increased and thereby the algorithm matrix is changed. For example, when a modified uniformly redundant array (MURA) is employed, the original matrix is h(x, y), x=1:m, y=1:n, which is denoted as follows:

$$h ( x , y ) = ( \begin{matrix}h ( 1 , 1 ) & h ( 1 , 2 ) & … & h ( 1 , n ) \\ h ( 2 , 1 ) & h ( 2 , 2 ) & … & h ( 2 , n ) \\ … & … & … & … \\ h ( m , 1 ) & h ( m , 2 ) & … & h ( m , n )\end{matrix} )$$

When h(x, y)=1, the position of the coordinates is at the center of the through hole. To prevent any two through holes from contact, a traditional method is to enlarge the hole spacing, and ensure that t=2Φ. Accordingly, the above method requires insertion of all-zero rows and columns in the original matrix. A new matrix is h_{NTHT}(x, y), x=1:2m−1, y=1:2n−1, which is denoted as follows:

$${h}_{NTHT} ( x , y ) = \{ \begin{matrix}h ( \frac{x + 1}{2} , \frac{y + 1}{2} ) , & x and y are both odd numbers ; \\ 0 , & either of x or y is an even number .\end{matrix}$$

Although the above processing method prevents contact of holes within a neighborhood and maintains stability of portions between holes, the aperture ratio is reduced. Generally, in the above processing method, the hole spacing is twice the hole diameter, such that the aperture ratio is only 25% of the original matrix h(x, y). In emission tomography, including SPECT and PET, aperture ratio directly affects the transmittance of the perforated plate, and hence affects detection sensitivity, thereby reducing the signal-to-noise ratio of images and image quality.

Application of the collimating apparatus according to the present invention to SPECT or PET requires no modification to the original matrix. More favorably, with the technical solution according to the present invention, the ratio of the hole spacing to the hole diameter is smaller than 2, generally smaller than 1.95. In this way, the stability of the portions between holes is ensured, and the aperture ratio is not excessively reduced. In addition, during detection, the transmittance is higher, thereby achieving high quality images.

What is claimed is:

1. A collimating apparatus for emission tomography, comprising: a perforated plate (1) that is disposed between a detector (2) and a to-be-detected object and provided with a plurality of through holes (5); wherein a minimum distance between central points of each two adjacent through holes (5) is t, and a distance from the central point of the through hole (5) to the wall of the through hole (5) is half of Φ, where t>Φ>t/2.

2. The collimating apparatus according to claim 1, wherein the through holes (5) are circular holes, the central point is the center of the circle, Φ is a diameter, and t>Φ>t/1.95.

3. The collimating apparatus according to claim 1, wherein the through holes (5) are arranged according to a matrix on the perforated plate (1); in the same row or in the same column, the minimum distance between the central points of the each two adjacent through holes (5) is t; Φ is twice a maximum distance or a minimum distance from the central point of the through hole (5) to the wall of the through hole (5).

4. The collimating apparatus according to claim 2, wherein the through holes (5) are diameter-variable holes, Φ is an average diameter, and t>Φ>t/1.95.

5. The collimating apparatus according to claim 1, wherein a shielding apparatus I (4) is disposed between the perforated plate (1) and the detector (2); and a shielding apparatus II (3) that is position-adjustable is disposed between the perforated plate (1) and the to-be-detected object.

6. The collimating apparatus according to claim 2, wherein a shielding apparatus I (4) is disposed between the perforated plate (1) and the detector (2); and a shielding apparatus II (3) that is position-adjustable is disposed between the perforated plate (1) and the to-be-detected object.

7. The collimating apparatus according to claim 3, wherein a shielding apparatus I (4) is disposed between the perforated plate (1) and the detector (2); and a shielding apparatus II (3) that is position-adjustable is disposed between the perforated plate (1) and the to-be-detected object.

8. The collimating apparatus according to claim 4, wherein a shielding apparatus I (4) is disposed between the perforated plate (1) and the detector (2); and a shielding apparatus II (3) that is position-adjustable is disposed between the perforated plate (1) and the to-be-detected object.

9. The collimating apparatus according to claim 1, wherein the perforated plate (1) is a planar coded aperture plate provided with holes that are evenly spaced according to a matrix function h(x, y), where (x, y) denotes coordinates of the planar coded aperture plate.

10. The collimating apparatus according to claim 2, wherein the perforated plate (1) is a planar coded aperture plate provided with holes that are evenly spaced according to a matrix function h(x, y), where (x, y) denotes coordinates of the planar coded aperture plate.

11. The collimating apparatus according to claim 3, wherein the perforated plate (1) is a planar coded aperture plate provided with holes that are evenly spaced according to a matrix function h(x, y), where (x, y) denotes coordinates of the planar coded aperture plate.

12. The collimating apparatus according to claim 4, wherein the perforated plate (1) is a planar coded aperture plate provided with holes that are evenly spaced according to a matrix function h(x, y), where (x, y) denotes coordinates of the planar coded aperture plate.

13. The collimating apparatus according to claim 1, wherein a perpendicular distance and/or a relative horizontal position between the perforated plate (1) and the detector (2) are/is changed by adjusting the perforated plate (1) and/or the detector (2).

14. The collimating apparatus according to claim 2, wherein a perpendicular distance and/or a relative horizontal position between the perforated plate (1) and the detector (2) are/is changed by adjusting the perforated plate (1) and/or the detector (2).

15. The collimating apparatus according to claim 3, wherein a perpendicular distance and/or a relative horizontal position between the perforated plate (1) and the detector (2) are/is changed by adjusting the perforated plate (1) and/or the detector (2).

16. The collimating apparatus according to claim 4, wherein a perpendicular distance and/or a relative horizontal position between the perforated plate (1) and the detector (2) are/is changed by adjusting the perforated plate (1) and/or the detector (2).

17. The collimating apparatus according to claim 5, wherein the opening of the shielding apparatus II (3) is adjusted by stretch and retraction, and a perpendicular distance and/or a relative horizontal position between the shielding apparatus II (3) and the perforated plate (1) are/is adjustable.

18. The collimating apparatus according to claim 9, wherein the matrix function h(x, y) is a modified uniformly redundant array, a uniformly redundant array, a random array, or a pseudo-random array.

19. The collimating apparatus according to claim 9, wherein the through holes are provided where the matrix function h(x, y)=1, and coordinates where the matrix function h(x, y)=1 are coordinates of the central point of the through hole (5).
